(19) United States
(12) Patent Application Publication
(10) Pub. No.: US 2026/0087451 A1
(43) Pub. Date: Mar. 26, 2026

(54) DYNAMIC CONTENT VIEWERSHIP ALIGNMENT BASED ON AGGREGATE VIEWER METADATA

(71) Applicant: INTERNATIONAL BUSINESS MACHINES CORPORATION, Armonk, NY (US)

(72) Inventors: Jeremy Ray Fox, Georgetown, TX (US); Melanie Dauber, Oceanside, NY (US); Zachary Augustus Silverstein, Georgetown, TX (US); Jacob Ryan Jepperson, St. Paul, MN (US); Logan Bailey, Atlanta, GA (US)

(21) Appl. No.: 18/894,771

(22) Filed: Sep. 24, 2024

(51) Int. Cl. G06Q 10/10

(52) U.S. Cl. CPC G06Q 10/10

(57) ABSTRACT

Dynamic updating of content viewership alignment based on aggregate viewer metadata is provided. In some embodiments, a virtual meeting schedule is read. The virtual meeting schedule includes a list of attendees and one or more pieces of content. Attendee data and content history are captured for each attendee based on the list of attendees. The content history is aggregated for the list of attendees. A relevancy score is generated for each of the one or more pieces of content based on the aggregated content history. Generating the relevancy score comprises determining a similarity component between each piece of content and the content history, determining a familiarity component based on each attendee, and an interaction component based on the content history. Each piece of content is annotated according to its relevancy score. The annotated one or more pieces of content are outputted in the virtual presentation system.

### TECHNICAL FIELD

Embodiments of the present disclosure are related to a system, method, and computer program product for dynamically summarizing and suggesting changes to content based on aggregate viewer data and metadata.

### BACKGROUND OF THE DISCLOSURE

Inefficiencies often exist in the duplication of data presented to users within presentations and team meetings.

To address these inefficiencies, a module identifying opportunities for offloading content based on viewers'current and projected consumption is needed. This module may help presenters save time and increase engagement by converting topics into summaries when attendees to a presentation have other meetings covering the same topics.

### SUMMARY

Here, a method, system, and computer program product is disclosed to dynamically update content viewership alignment based on aggregate viewer metadata.

In one embodiment, a method for updating content relevancy in a virtual presentation system comprises reading a virtual meeting schedule, the virtual meeting schedule including a list of attendees and one or more pieces of content; capturing attendee data and content history for each attendee based on the list of attendees; aggregating the content history for the list of attendees; generating a relevancy score for each of the one or more pieces of content based on the aggregated content history, generating the relevancy score comprising determining a similarity component between each piece of content and the content history, determining a familiarity component based on each attendee, and an interaction component based on the content history; annotating each piece of content according to its relevancy score; and outputting the annotated one or more pieces of content in the virtual presentation system.

In an alternative embodiment, a system for updating content relevancy in a virtual presentation system comprises a computing node comprising a computer readable storage medium having program instructions embodied therewith, the program instructions executable by a processor of the computing node to cause the processor to perform a method comprising reading a virtual meeting schedule, the virtual meeting schedule including a list of attendees and one or more pieces of content; capturing attendee data and content history for each attendee based on the list of attendees; aggregating the content history for the list of attendees; generating a relevancy score for each of the one or more pieces of content based on the aggregated content history, generating the relevancy score comprising determining a similarity component between each piece of content and the content history, determining a familiarity component based on each attendee, and an interaction component based on the content history; annotating each piece of content according to its relevancy score; and outputting the annotated one or more pieces of content in the virtual presentation system.

In another alternative embodiment, a computer program product for updating content relevancy in a virtual presentation system comprises a computer readable storage medium having program instructions embodied therewith, the program instructions executable by a processor to cause the processor to perform a method comprising reading a virtual meeting schedule, the virtual meeting schedule including a list of attendees and one or more pieces of content; capturing attendee data and content history for each attendee based on the list of attendees; aggregating the content history for the list of attendees; generating a relevancy score for each of the one or more pieces of content based on the aggregated content history, generating the relevancy score comprising determining a similarity component between each piece of content and the content history, determining a familiarity component based on each attendee, and an interaction component based on the content history; annotating each piece of content according to its relevancy score; and outputting the annotated one or more pieces of content in the virtual presentation system.

### BRIEF DESCRIPTION OF THE DRAWINGS

The accompanying drawings, which are incorporated into and constitute a part of this specification, illustrate various exemplary embodiments and together with the description, serve to explain the principles of the disclosed embodiments.

FIG. 1 is a flowchart illustrating an exemplary method for updating content relevancy in a virtual presentation system, in accordance with one or more embodiments of this disclosure.

FIG. 2A-2B is a block chart illustrating an exemplary workflow of a system for updating content relevancy of a virtual presentation, in accordance with one or more embodiments of this disclosure.

FIG. 3 is an exemplary computing node.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

2 As used herein, the term “exemplary” is used in the sense of “example,” rather than “ideal.” Moreover, the terms “a” and “an” herein do not denote a limitation of quantity, but rather denote the presence of one or more of the referenced items.

The increasing demand for the efficient use of time and resources in presentations and team meetings has highlighted the need for a solution identifying opportunities for offloading content based on aggregate viewer metadata. This solution may identify redundant content across different communities and suggest changes to the agenda based on past topical data consumption. In some embodiments, a solution may employ ML algorithms for analyzing data and NLP for summarizing content when and where required. Embodiments of the present disclosure help presenters save time, increase engagement, and tailor content to the audience's needs, while avoiding viewer fatigue by avoiding duplicate meetings or topics.

Embodiments of the present disclosure may aid in avoiding duplicate meetings or topics by identifying redundant content across different communities. This may be achieved by identifying past topical data consumption across the different communities. The module can suggest changes to the agenda, such as joining one meeting for details, one for summary, and one for feedback, or skipping altogether. This not only saves time for users but also increases engagement, tailors content to the audience's needs, and avoids viewer fatigue to ensure the audience is receiving new and relevant information while providing valuable insights into aggregated interest.

The increasing demand for the efficient use of time and resources in presentations and team meetings has highlighted the need for a solution identifying opportunities for offloading content based on aggregate viewer metadata. Embodiments of the present disclosure identify redundant content across different communities and suggest changes to the agenda based on past topical data consumption. Some embodiments employ ML algorithms for analyzing data and NLP for summarizing content when and where required. Accordingly, embodiments of the present disclosure help presenters save time, increase engagement, and tailor content to the audience's needs, while avoiding viewer fatigue by avoiding duplicate meetings or topics. Some embodiments help presenters ensure that content isn't presented to individuals who have already consumed the content through web conferences, for example, even if the content has been previously consumed in a slightly different medium.

Embodiments of the present disclosure aid provide valuable insights by creating a dynamic content summarization system based on aggregate viewer metadata. Accordingly, this helps reduce the effort required for presentations and team meetings by identifying opportunities for offloading content, identifying redundant content across different communities, and suggesting changes to the agenda based on past topical data consumption.

Some embodiments of the present disclosure utilize machine learning algorithms and natural language processing techniques to dynamically summarize content based on aggregate viewer data and metadata and analyze the data dynamically from the viewers in real time. Machine learning models may include supervised or unsupervised learning algorithms and natural language processing to analyze text data and summarize content. These models may additionally employ enabling technologies to store, process, and analyze the data, utilizing an application program interface and user interface for easy access. In some embodiments, opportunities for offloading content may be identified. In some embodiments, natural language processing and sentiment analysis may be used to summarize content and suggest changes to content.

Some embodiments identify opportunities for offloading content from a presentation or team meeting, identifying redundant content from across different communities. Suggestions may be made to change the presentation or meeting agenda based on the past topical data consumption.

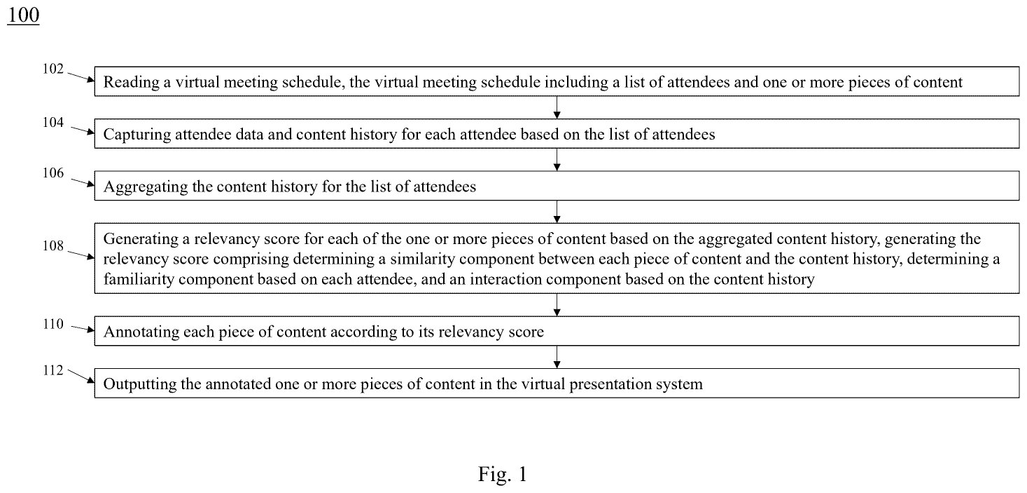

FIG. 1 is a flowchart of a method 100 for updating content relevancy in a virtual presentation system. The method 100 (i.e., steps 102-112) may include one or more of the following steps.

In step 102, the method may include reading a virtual meeting schedule, the virtual meeting schedule including a list of attendees and one or more pieces of content. The one or more pieces of content may comprise a content file, for example a PowerPoint presentation or a Word document. The list of attendees may be virtual attendees who review the content file via a virtual presentation, such as a webinar. The virtual meeting schedule may include the list of attendees and the one or more pieces of content at the time that the schedule is initially sent out to attendees, or the content and/or attendees information may be added on an ad-hoc basis until the meeting begins.

In step 104, the method may include capturing attendee data and content history for each attendee based on the list of attendees. Attendee data may include data from multiple sources, such as from instant messaging applications, emails, content repositories, local file systems, and/or collaborative meeting invitations. Attendee data may be found by searching each source by the attendee's username, email address, or other identification, and then querying each source to find data associated with each attendee. Data sources may be integrated by application programming interfaces (APIs), or other direct connections such as databases or similar connections.

Capturing attendee data may be performed by a machine learning model, artificial intelligence (AI) algorithm, and/or artificial neural network.

In step 106, the method may include aggregating the content history for the list of attendees. The aggregated content history may provide insight into how many of the attendees have consumed or viewed the content prior to the presentation. For example, the aggregated content history of the attendees may be associated or compared to the one or more pieces of content in the meeting schedule. This association or comparison may provide a baseline level of interest for the list of attendees.

In some embodiments, the method may aggregate the scoring of similarity, familiarity, and interaction for each piece of content, and associates that content to the given content on a presentation's materials. Presentation materials may receive a similarity scoring and familiarity scoring for the user to know an aggregate and an average, mean, and median of time spent on similar content across the list of attendees.

In step 108, the method may include generating a relevancy score for each of the one or more pieces of content based on the aggregated content history, generating the relevancy score comprising determining a similarity component between each piece of content and the content history, determining a familiarity component based on each attendee, and an interaction component based on the content history. The familiarity score may be associated with each attendee. If the content is deemed to be relevant, the content will receive the similarity score by processing content history. The content history may be processed through Page, an OCR engine, and/or text through LSTM and co-sine similarity. Any content with a high level of similarity may be processed for two user interaction metrics, if available. User interaction metrics may include, for example, recency and attentiveness. Recency may include information about when content was consumed by the attendee. Attentiveness may include how focused the attendee was during presentation of the content, or the level of interaction between the attendee and the content.

In step 110, the method may include annotating each piece of content according to its relevancy score. For example, some sub-content in each piece of content may be annotated with relevant and related familiarity scoring. This may allow the presenter of the content to quickly cover familiar topics to the attendees and spend more time on content less familiar to the attendees. Scoring the pieces of content may comprise assigning a binary value to each piece of content, a percentage, or any other suitable method of scoring.

In step 112, the method may include outputting the annotated one or more pieces of content in the virtual presentation system.

In some embodiments, the method may additionally include generating a total familiarity score for the list of attendees. This total familiarity score may be appended to a portion of the content file as included in the virtual meeting schedule.

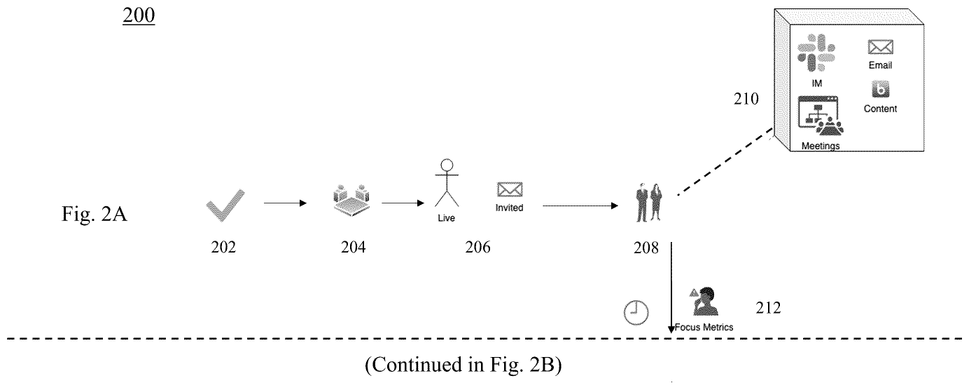

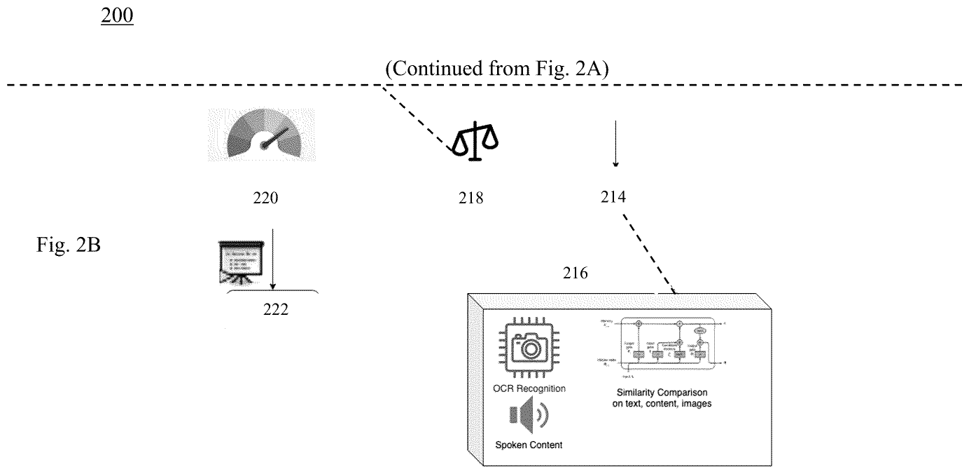

FIG. 2A-2B is a block chart illustrating an exemplary workflow 200 for updating content relevancy of a virtual presentation. In exemplary workflow 200 (i.e., steps 202-222) may be performed automatically or in response to an input from a user. In step 202, a user (such as a presenter of the content in a virtual meeting or meeting host) may opt into a module for the method. The module housing the method may primarily reside on a cloud-based server, in some embodiments.

In step 204, the workflow may include adding or capturing meeting content by the module. For example, adding or capturing may be performed by accessing the user's content history, including but not limited to sources such as an instant messaging account, an email account, a content repository, a local file system, and/or a collaborative meeting invite. The content history sources at a per user basis may be integrated into the method 200 by an application program interface or a direct connection to the module, such as a database or other similar connectors.

In some embodiments, the meeting host may schedule a meeting with a list of individuals and may attach content to the meeting schedule, or associate content with the meeting schedule. Attachment or association of content may be performed proactively at the time of scheduling the meeting, or may be performed ad-hoc at the time of screensharing or during the meeting.

In step 206, the workflow may include the invitation module capturing an attendee list. The attendee list may include email addresses or instant messaging handles associated with each attendee, or other suitable identifiers. For each attendee, the module may query the email, instant messaging, content repository, local file system, or other collaborative meeting invites associated with the attendee using the email address, instant messaging handle, or other identifier associated with the attendee.

In step 208, the workflow may include retrieving attendee collaborative history 210. Content retrieved from the email, instant messaging, content repository, local file system, or other collaborative meeting invites associated with each attendee may be processed by the module to build a similarity binding and scoring system.

In step 212, the workflow may include processing the content history for recency and focus against a per user basis.

In step 214, the workflow may include retrieving relevant content based on processing for similarity. Content with a high level of similarity to the scheduled meeting content is further processed for second user interaction metrics, if available. Second user interaction metrics may include a recency metric, associated with when the similar content was consumed by the attendee, as well as an attentiveness metric, associated with how focused the attendee was on the content or a level of interaction with the content by the attendee. For content associated with an attendee and deemed relevant to the scheduled meeting, the content may also receive a similarity score by processing the content using Page, an OCR engine, and/or text through LTSM and co-sine similarity processing in step 216.

In step 218, the workflow may include at a per attendee basis, comparing attendee's viewed content with presentation content. The module may aggregate the scoring of similarity, familiarity, and interaction for each piece of content and associate that content to given content in the presentation materials.

In step 220, the workflow may include generalizing and providing an overall content and a per page familiarity score. The general presentation materials may receive a similarity scoring and familiarity scoring for the meeting host to know an aggregate and an average, mean, median of time spent on similar content for all of the attendees

In step 222, the workflow may include annotating content, such as Powerpoint slides, with familiarity scoring for reorganization. For example, the sub content of each slide is annotated with the relevant and related familiarity scoring so the meeting host knows what content may be gone through fast and what content should be taken more time overall. This scoring may be done in many ways or through a basic scoring of 0-1

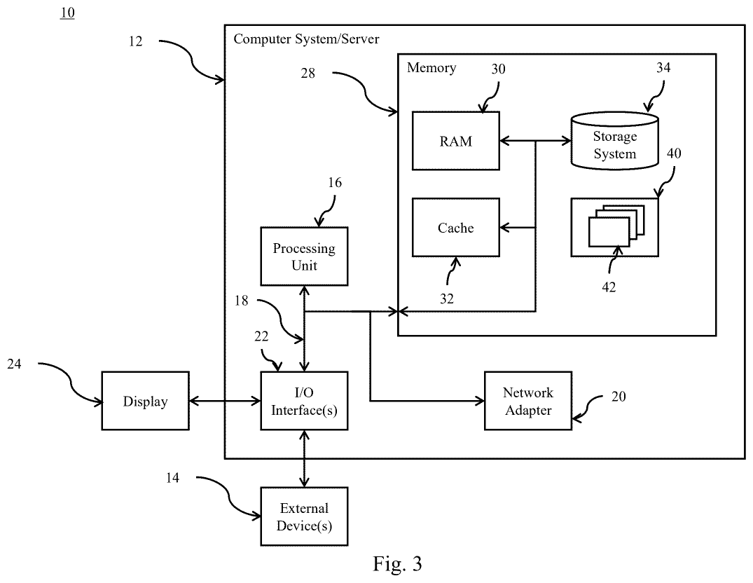

Referring now to FIG. 3, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for updating content relevancy in a virtual presentation system, the method comprising:
reading a virtual meeting schedule, the virtual meeting schedule including a list of attendees and one or more pieces of content;
capturing attendee metadata and content history for each attendee based on the list of attendees;
aggregating the content history for the list of attendees;
generating a relevancy score for each of the one or more pieces of content based on the aggregated content history, generating the relevancy score comprising determining a similarity component between each piece of content and the content history, determining a familiarity component based on each attendee, and an interaction component based on the content history;
annotating each piece of content according to its relevancy score; and
outputting the annotated one or more pieces of content in the virtual presentation system.

2. The method of claim 1, wherein the content history includes one or more of instant messaging, email, content repositories, a local file system, and/or a collaborative meeting invitation.

3. The method of claim 1, wherein the content history is provided by querying an application programming interface and/or a database.

4. The method of claim 1, wherein each piece of content comprises one or more asset captured via optical character recognition.

5. The method of claim 4, wherein determining a similarity component comprises using similarity processing to define one or more similar assets.

6. The method of claim 1, further comprising processing on screen content during a virtual presentation.

7. The method of claim 1, further comprising comparing a first similarity component associated with a first attendee with a second similarity component associated with a second attendee.

8. The method of claim 1, wherein capturing attendee data comprises capturing one or more of an email address, username, or identifier associated with the attendee.

9. The method of claim 1, wherein the relevancy score is above a predetermined threshold.

10. The method of claim 1, wherein the similarity score is generated by co-sine similarity.

11. The method of claim 1, wherein the similarity score is above a predetermined threshold.

12. The method of claim 9, further comprising processing each piece of content for user interaction metrics.

13. The method of claim 10, wherein user interaction metrics comprise at least one of recency and attentiveness.

14. The method of claim 1, wherein each piece of content is a slide associated with a virtual presentation.

15. A system for updating content relevancy in a virtual presentation system, the system comprising:
a computing node comprising a computer readable storage medium having program instructions embodied therewith, the program instructions executable by a processor of the computing node to cause the processor to perform a method comprising:
reading a virtual meeting schedule, the virtual meeting schedule including a list of attendees and one or more pieces of content;
capturing attendee metadata and content history for each attendee based on the list of attendees;
aggregating the content history for the list of attendees;
generating a relevancy score for each of the one or more pieces of content based on the aggregated content history, generating the relevancy score comprising determining a similarity component between each piece of content and the content history, determining a familiarity component based on each attendee, and an interaction component based on the content history;
annotating each piece of content according to its relevancy score; and
outputting the annotated one or more pieces of content in the virtual presentation system.

16. A computer program product for updating content relevancy in a virtual presentation system, the computer program product comprising a computer readable storage medium having program instructions embodied therewith, the program instructions executable by a processor to cause the processor to perform a method comprising:
reading a virtual meeting schedule, the virtual meeting schedule including a list of attendees and one or more pieces of content;
capturing attendee metadata and content history for each attendee based on the list of attendees;
aggregating the content history for the list of attendees;
generating a relevancy score for each of the one or more pieces of content based on the aggregated content history, generating the relevancy score comprising determining a similarity component between each piece of content and the content history, determining a familiarity component based on each attendee, and an interaction component based on the content history;
annotating each piece of content according to its relevancy score; and
outputting the annotated one or more pieces of content in the virtual presentation system.
